(19) United States
(12) Patent Application Publication
(10) Pub. No.: US 2024/0182375 A1
(43) Pub. Date: Jun. 6, 2024

(54) SYSTEM AND METHOD FOR PRODUCTION OF CALCIUM OXIDE WITH REDUCED CARBON FOOTPRINT

(71) Applicant: Peregrine Hydrogen Inc., Santa Cruz, CA (US)

(72) Inventors: Ian McKay, Santa Cruz, CA (US); Stefan Omelchenko, Santa Cruz, CA (US); Matthew Shaner, Santa Cruz, CA (US); Sam Faucher, Santa Cruz, CA (US)

(73) Assignee: Peregrine Hydrogen Inc., Santa Cruz, CA (US)

(21) Appl. No.: 18/527,042

(22) Filed: Dec. 1, 2023

Related U.S. Application Data
(60) Provisional application No. 63/385,888, filed on Dec. 2, 2022.

(51) Int. Cl. C05C 3/00; C01B 17/74; C04B 7/345; G21F 9/02

(52) U.S. Cl. CPC C05C 3/00; C01B 17/745; C04B 7/3453; G21F 9/02

(57) ABSTRACT

A method can include reducing calcium sulfate to calcium sulfide, converting calcium sulfide to calcium oxide, optionally using the calcium oxide to form a product, optionally oxidizing sulfur dioxide to sulfuric acid, and optionally using the sulfuric acid in fertilizer production.

### CROSS-REFERENCE TO RELATED APPLICATIONS

This application claims the benefit of U.S. Provisional Application No. 63/385,888 filed 2 Dec. 2022, which is incorporated in its entirety by this reference.

### TECHNICAL FIELD

This invention relates generally to the calcium oxide field, and more specifically to a new and useful system and method in the calcium oxide field.

### BRIEF DESCRIPTION OF THE FIGURES

FIG. 1 is a flow chart representation of an example of the method.

FIGS. 2A, 2B, and 2C are chemical reaction equations for exemplary processes performed in examples of the method.

FIG. 3 is a schematic representation of an example of a sulfur dioxide depolarized electrolyzer.

FIG. 4 is a schematic representation of an example of the method.

FIG. 5 is a diagram of a reaction coordinate for an example of the method using hydrogen as a reducing agent.

FIG. 6 is a diagram of a reaction coordinate for an example of the method using sulfur as a reducing agent.

### DETAILED DESCRIPTION

The following description of the embodiments of the invention is not intended to limit the invention to these embodiments, but rather to enable any person skilled in the art to make and use this invention.

### 1. Overview

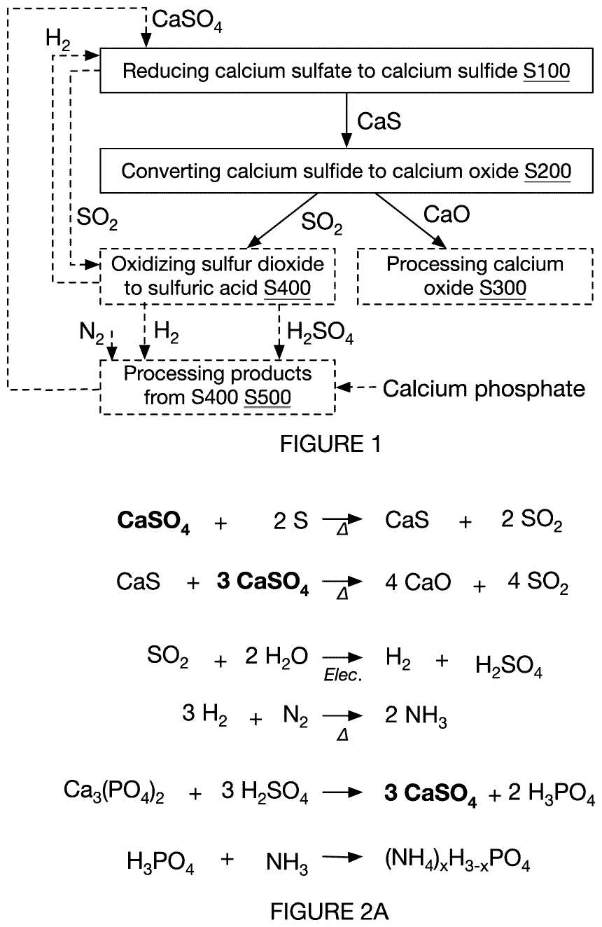

As shown in FIG. 1, a method can include reducing calcium sulfate to calcium sulfide S100, converting calcium sulfide to calcium oxide S200, optionally using the calcium oxide to form a product S300, optionally oxidizing sulfur dioxide to sulfuric acid S400, optionally using the sulfuric acid in fertilizer production S500, and/or any suitable steps.

The method preferably functions to convert calcium sulfate into calcium oxide with a small carbon footprint (e.g., low direct carbon emission, low indirect carbon emissions such as resulting from shipping materials between locations, etc.). For instance, embodiments of the method can operate in a closed or nearly closed loop cycle where products from one process step are leveraged by a subsequent process step. Relatedly, embodiments of the method can be performed on site (or nearly onsite) of locations that calcium sulfate is formed (e.g., phosphate fertilizer production facilities, titanium dioxide production facilities, etc.) and/or acquired (e.g., mined). The calcium oxide can be used for cement manufacturing (e.g., clinker formation, Portland cement production, calcium aluminate cement, etc.), for concrete production (e.g., aerated concrete), for agricultural purposes (e.g., aglime), steelmaking (e.g., basic oxygen steel making process), glass production, soil treatment (e.g., increase the load carrying capacity of clay soil), heat production (e.g., by leveraging the heat of hydration or alternatively a heat sink by evaporating water from hydrated calcium oxide), a food additive (e.g., acidity regulator, flour treatment agent, leavener, etc.), as an alkali source, as a detector (e.g., for water in the petroleum industry), in the paper industry (e.g., to regenerate sodium hydroxide from sodium carbonate at a pulp mill), for flue gas cleaning (e.g., desulfurization), water desiccant, mining (e.g., to break rocks), for carbon dioxide sequestration and/or capture, and/or for any suitable application(s).

As an illustrative example, calcium sulfate formed during phosphate fertilizer production can be reduced to calcium sulfide which can then be reacted with additional calcium sulfate to produce (e.g., comproportionated into) calcium oxide and sulfur dioxide. In this illustrative example, the sulfur dioxide can be oxidized to form sulfuric acid which can then be used to make phosphoric acid (e.g., to be used in a phosphate fertilizer plant) and calcium sulfate. However, the method can function in any manner. While the use of calcium sulfate is used herein, the same or a similar process can be realized for other sulfates (e.g., alkali sulfates, alkaline earth metal sulfates, transition metal sulfates, rare earth metal sulfates, post-transition metal sulfates, etc.) and the respective sulfides and/or oxides thereof.

### 2. Technical Advantages

Variants of the technology can confer one or more advantages over conventional technologies.

First, variants of the technology can reduce a carbon footprint of calcium oxide production. For instance, by performing the reduction of calcium sulfate with a non-carbonaceous (e.g., carbon containing) reducing agent, the amount of carbon dioxide produced is decreased. Relatedly, these variants can have an additional benefit where sulfur dioxide produced by the reduction of calcium sulfate and/or comproportionation of calcium sulfide can have a higher purity (and/or can be easier to purify to high purity—carbon dioxide and sulfur dioxide can be difficult to separate making purification of sulfur dioxide from the mixture challenging).

Second, variants of the technology can convert refinery waste calcium sulfates (e.g., phosphogypsum, titanium gypsum, etc.) into useable products. For example, variants of the technology can leverage processes to convert the refinery waste calcium sulfates into calcium oxide (in spite of impurities, leveraging the impurities, etc.). In another example, the refinery waste calcium sulfates can be purified (e.g., using a hydrocyclone to separate radium sulfate, uranium compounds, etc. from the calcium sulfates) prior to processing. In another example, the calcium oxide produced from the refinery waste calcium sulfate can be mixed with calcium oxide from a second source and/or the refinery waste calcium sulfate can be mixed with calcium sulfate from a second source (e.g., to achieve a radioactivity less than a threshold radioactivity).

Third, the inventors have discovered that a sulfur depolarized electrolyzer can enable multiple integrations into the production of calcium oxide. For instance, a sulfur depolarized electrolyzer can generate (e.g., coproduce) sulfuric acid with hydrogen. For instance, the sulfuric acid can be used to generate calcium sulfate (e.g., as well as phosphoric acid from calcium phosphate) and the hydrogen can be used to reduce the and/or provide heat for the reduction of the calcium sulfate to calcium sulfide. Relatedly, the calcium oxide can be used to form aglime which can be used as a soil additive (e.g., in combination with a phosphate fertilizer derived from the phosphoric acid). Moreover, some variants of the depolarizer electrolyzer can further leverage the integration between processing steps performed at a shared location by using heat, electricity, pressure, and/or other nonchemical outputs generated during processes in subsequent processes. Relatedly, the coproduction can also be beneficial for enabling recycling of chemical species (e.g., byproducts, unreacted species, etc.) thereby enhancing an efficiency of the process.

Fourth, variants of the technology can enable direct air carbon capture. For example, the calcium oxide can capture carbon dioxide from the air (such as forming calcium carbonate).

However, further advantages can be provided by the system and method disclosed herein.

### 3. Method

As shown in FIG. 1, a method can include reducing calcium sulfate to calcium sulfide S100, converting calcium sulfide to calcium oxide S200, optionally using the calcium oxide to form a product S300, optionally oxidizing sulfur dioxide to sulfuric acid S400, optionally using the sulfuric acid in fertilizer production S500, and/or any suitable steps.

The method can function to recycle gypsum (e.g., refinery waste gypsum) and/or otherwise convert calcium sulfate into calcium oxide (and/or products derived therefrom or related thereto such as calcium carbonate, calcium hydroxide, calcium peroxide, etc.). Examples of calcium sulfate sources that can be used in the method include mineral calcium sulfate (e.g., anhydrite, gypsum, selenite, bassanite, etc. such as mined minerals, processed minerals, etc.), recovered calcium sulfate, calcium sulfate byproducts (e.g., titanium gypsum, phosphogypsum, flue-gas desulfurization calcium sulfate, calcium sulfate from zinc refining, calcium sulfate from hydrogen fluoride production, calcium sulfate recovered from drywall, etc.). However, the method can alternatively function.

In a specific example, the method can be performed in a single reactor (e.g., furnace, kiln, electrolyzer, oven, fluidized bed, etc.) and/or a plurality of reactors. For instance, different reactions can be performed in separate stages which can be beneficial for producing products with high purity. For example, by performing S100 and S200 as separate stages, carbonaceous reducing agents can be used in S100 without contaminating sulfur dioxide produced in S200. However, S100 and S200 can be performed in the same stage (e.g., same reactor—particularly when reducing agents, heating agents, etc. that are readily separated from SO₂ are used).

The method can be performed continuously and/or intermittently (e.g., only when green electricity such as solar, wind, tide, etc. is available). All or portions of the method can be performed in iteratively, contemporaneously, simultaneously (e.g., concurrently), asynchronously, periodically, and/or at any other suitable time. All or portions of the method can be performed automatically, manually, semi-automatically, and/or otherwise performed. The method (e.g., each step thereof) is preferably performed in a single location (e.g., single manufacturing site, single geographic region). However, one or more products, byproducts, materials, and/or other product can be transported to a different location to perform the method (e.g., S100, S200, S300, S400, and/or S500 can be performed in different locations).

Converting calcium sulfate to calcium sulfide S100 functions to convert the calcium sulfate source (or a portion thereof) into calcium sulfide. S100 can be performed in an oven (e.g., vacuum oven, furnace, etc.), kiln, fluidized bed reactor (e.g., flowing an oxidizing gas, air, oxygen, steam, etc. at a sufficient pressure to fluidize the reagent(s)), plug flow reactor, continuous stirred-tank reactor, batch reactor, semi-batch reactor, catalytic reactor, and/or in any suitable reaction vessel.

As the conversion of calcium sulfate to calcium sulfide is endothermic, S100 typically requires heating. For instance, S100 can be performed at a temperature between about 500 and 1500° C. (e.g., 600° C., 750° C., 800° C., 900° C., 1000° C., 1100° C., 1200° C., 1300° C., 1400° C., values or ranges therebetween, etc.). However, S100 can be performed at any suitable temperature. In some variations, S100 can include a plurality of temperature steps (e.g., to calcine the calcium sulfate, to dehydrate the calcium sulfate, etc. where steps can be substantially constant temperature, periods of time with temperature ramping rates less than a threshold rate, etc.) such as a first temperature step (e.g., calcining step at a temperature between about 100° C. and 500° C.) and a second step (e.g., a conversion step between about 500 and 1500° C.). However, S100 can be performed without heating. Heat can be provided radiatively, conductively, convectively, and/or in any manner. In variants, heating elements (e.g., within the reaction vessel, integrated into the reaction vessel container, outside the reaction vessel, etc.) can be heated (e.g., electrically), heat can be provided via solar radiation, heat can be provided by combustion of a species, and/or heat can be provided in any manner.

Variants of S100 can include: decomposing the calcium sulfate into calcium sulfide (and oxygen, sulfur dioxide, calcium oxide, or other products such as via thermal decomposition), electrolysis (e.g., molten salt electrolysis of calcium sulfate into calcium sulfide, oxygen, sulfur dioxide, etc.), (chemically) reducing the calcium sulfate S150, comproportionation of calcium sulfate with a metal sulfide (e.g., impurity sulfides generated by other instantiations of the method in S100 or recovered in S200, alkaline earth metal sulfides, alkali metal sulfides, etc. to result in a metal oxide, calcium oxide, calcium sulfide, sulfur dioxide, and/or other byproducts), and/or any suitable reactions and/or processes.

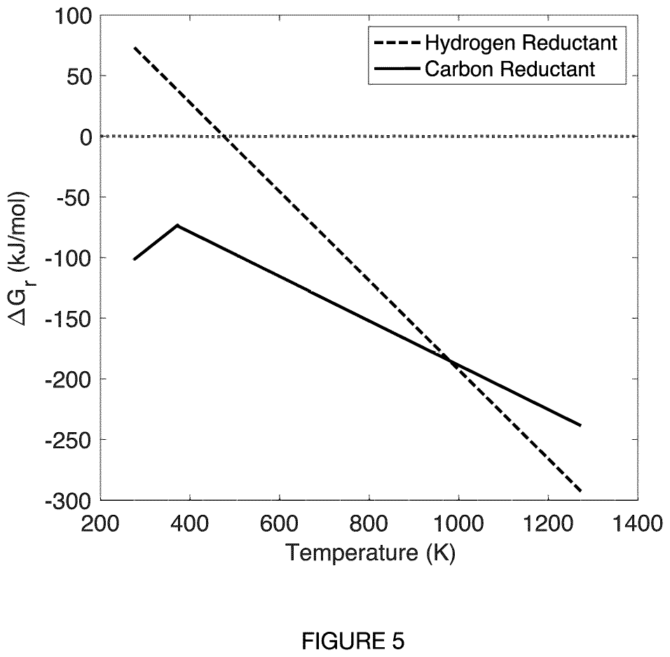

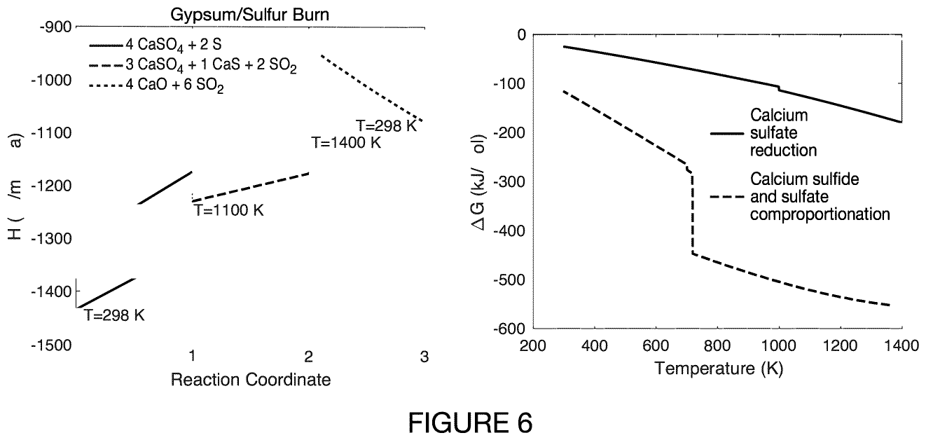

Variants that include reducing the calcium sulfate S150 can include reducing the calcium sulfate using a reducing agent. In some embodiments, a non-carbonaceous (e.g., non-carbon containing material such as sulfurous material, elemental sulfur, hydrogen, hydrogen sulfide, alkali metals, reaction coordinates as shown for example in FIG. 5 or FIG. 6, etc.) reducing agent can be preferred (e.g., as the byproducts from the reduction reaction can be solid and/or gaseous products that are readily separated from sulfur dioxide). In other embodiments, carbonaceous reducing agents (e.g., carbon monoxide, coke, coal, natural gas, hydrocarbons, methane, ethane, propane, etc.) can be used. In other embodiments, a combination of non-carbonaceous and carbonaceous reducing agents can be used (e.g., for instance in a combination that achieves a threshold sulfur dioxide concentration without further purification, that achieves a threshold sulfur dioxide concentration after condensation of water or other condensable products, etc.). However, any suitable reducing agent(s) can be used.

In some variations of S150, the reducing agent can be used as a combustible material for the introduction of heat for the reduction reaction. As an illustrative example, sulfur and/or hydrogen sulfide can act as both a reducing agent for the calcium sulfate and can be combusted (e.g., oxycombusted) to provide heat for the reduction of calcium sulfate (e.g., resulting in the production of sulfur dioxide, water, etc.). However, any suitable materials can be used to provide heat.

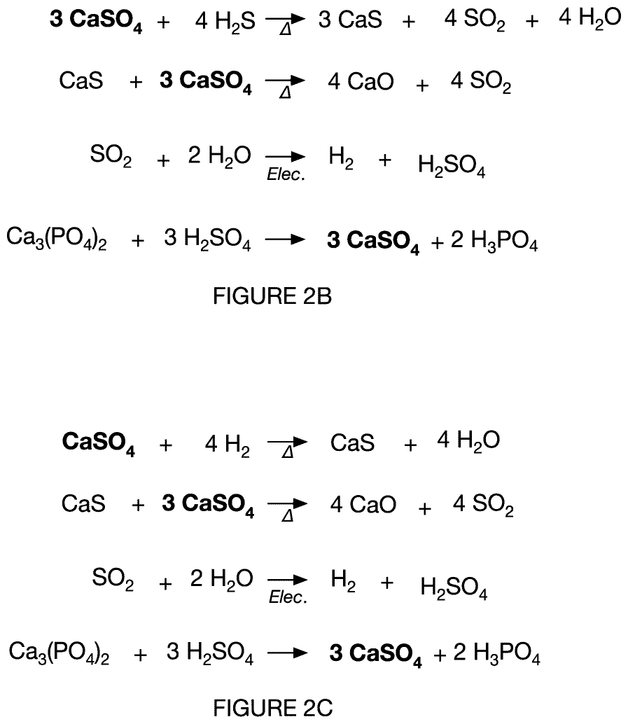

Typically, S150 is performed with an excess of reducing agent, which can be beneficial as combustion of the excess reducing agent can provide heat for a reaction (e.g., reaction(s) in S100, reaction(s) in S200, reaction(s) in S300, reaction(s) in S400, reaction(s) in S500, etc.; as shown for example in FIG. 5). As an illustrative example, for stoichiometric reduction of 1 equivalent (e.g., mole) of calcium sulfate to calcium sulfide, 2 equivalents (e.g., moles) of sulfur are theoretically required. In this illustrative example, the reduction can be performed using 3 equivalents, 5 equivalents, 7 equivalents, 10 equivalents, 20 equivalents, 25 equivalents, 50 equivalents, 100 equivalents, values and/or ranges therebetween, and/or any suitable amount of reducing agent. In related illustrative examples, the reduction of 1 equivalent of calcium sulfate to calcium oxide using sulfur (e.g., by combining S100 and S200, the combination of reaction 1 and reaction 2 in FIG. 2, reaction coordinate and free energy as shown for example in FIG. 6, etc.) would require 0.5 equivalents of sulfur (for the reduction only). Similar equivalent excesses (e.g., ratios) can be used for reducing agents with different stoichiometric equivalents in the reaction. In a variation of this illustrative example, the number of equivalents of reducing agent can be between about 0.5 and 10 times (e.g., 1×, 1.5×, 2×, 2.5×, 3×, 3.5×, 4×, 5×, 6×, 7×, 7.5×, 8×, 9×, values or ranged therebetween, etc.) the number of equivalents of calcium sulfate. In some variations, the oxidation of the reducing agent can supply all or substantially all (e.g., >90% of, >95% of, etc.) of the heat required for the reduction. However, in other variations, additional heat may need to be supplied (e.g., electrical heating, additional combustible material added, etc.). However, any suitable amount of reducing agent can be used (e.g., approximately matching a stoichiometry of the reduction, less than a stoichiometric amount such as to induce reduction of a portion of the calcium sulfate such as to leverage the remaining calcium sulfate in S200, etc.).

S100 is preferably performed in an oxidizing environment (e.g., to promote, facilitate, enable, etc. combustion of a combustible material to heat the reaction vessel and promote reactions). Exemplary oxidizing environments include: air, oxygen enriched air (e.g., air with a portion up to and including all nitrogen and/or other minority species removed), oxygen, ozone, halogens (e.g., fluorine, chlorine, bromine, iodine, combinations thereof, etc.), combinations thereof, and/or other suitable oxidizing environments. However, S100 can be performed in an inert environment (e.g., helium, neon, argon, krypton, xenon, nitrogen, etc.) and/or reducing environment (e.g., using a gaseous reducing agent such as vaporized magnesium, sulfur, hydrogen, etc.), particularly (but not exclusively) when heat is supplied from external the reaction vessel and/or an exothermic reduction reaction. A pressure of S100 is typically approximately 1 atm. However, the pressure can be greater than and/or less than 1 atm.

In some embodiments, the calcium sulfate source (particularly, but not exclusively, phosphogypsum, titanium gypsum, gypsum produced in flue-gas desulfurization, or other refinery waste gypsum) and/or the resulting calcium sulfide can include significant impurity (e.g., gangue material) levels. For instance, refinery waste gypsum can have significant levels of radioactive elements (such as uranium, radium, radon, thorium, protactinium, polonium, astatine, lead, bismuth, mercury, etc.), heavy metals (e.g., cadmium, lead, mercury, bismuth, thallium, tin, rhodium, indium, osmium, etc.), fluorides, silica, organic matters, and/or alkalis. As examples of a significant impurity level, the calcium sulfate (and/or resulting calcium sulfide) may have a radioactivity exceeding a safe and/or permissible radioactivity (e.g., as measured on an absolute basis such as 0.1 pCi/g, 1 pCi/g, 10 pCi/g, or 100 pCi/g), the calcium sulfate (and/or resulting calcium sulfide) may have or release a greater than threshold (e.g., according to a health authority standard) amount of organic material, the calcium sulfate (and/or resulting calcium sulfide) may undergo additional (often undesirable) side reactions, and/or the calcium sulfate (and/or resulting calcium sulfide) can otherwise have a significant impurity level (e.g., as measured on an absolute basis such as 1 ppb, 10 ppb, 100 ppb, 1000 ppb, 10 ppm, 100 ppm, etc.). When significant impurity levels are present, S100 can include mitigation steps to reduce the impurity(s) and/or reduce an impact of the impurity(s). For instance, S100 can include purifying the calcium sulfate and/or resulting calcium sulfide (e.g., separating or removing the impurity(s) such as using an ultracentrifuge, hydrocyclone, solvents, reactants, etc.), mixing the calcium sulfate (and/or resulting calcium sulfide) with a second calcium sulfate and/or calcium sulfide source (e.g., mined gypsum, anhydrite, selenite, bassanite, oldhamite, calcium sulfate derived from decomposition of limestone, mineral lime, portlandite, dehydrogenated portlandite, etc.), and/or other suitable steps. When the calcium sulfate and/or calcium sulfide is mixed with a second source of calcium sulfate and/or calcium sulfide, the relative amounts of each are preferably chosen such that the resulting calcium sulfate and/or calcium sulfide has less than the threshold amount of impurities (e.g., an insignificant amount of impurities rather than a significant amount of impurities). After purification and/or other mitigation steps, the calcium sulfate and/or calcium sulfide can be >80% pure, >85% pure, >90% pure, >95% pure, >97% pure, >99% pure, >99.5% pure, >99.9% pure, >99.95% pure, >99.99% pure, >99.995% pure, >99.999% pure, have a purity with a range therebetween, have a purity less than 80% pure (e.g., where the calcium sulfate and/or calcium sulfide is mixed with an impurity that provides technical advantages for a downstream process), and/or can have any suitable purity. In some variants, the reactions of S100 can facilitate separation such as by producing insoluble and/or soluble material that are more readily washed using one or more solvents. As an example, calcium sulfide is largely insoluble in water whereas sulfates are typically soluble therefore impurity sulfates can be removed from calcium sulfide using water washes.

In some variations, the impurities can be recovered and retained (e.g., until a threshold amount is acquired where the remaining impurities can be recovered, separated, and/or otherwise handled).

The calcium sulfate and/or calcium sulfide can be purified chemically (e.g., acid leaching and neutralization, chelation, comproportionation, etc.), physically (e.g., sieving or other techniques that separate impurity(s) based on particle size, magnetic separation, floatation, etc.), thermally, and/or using any suitable purification methods. In some variations, the calcium sulfate and/or calcium sulfide can be purified in a manner as described below for calcium oxide. However, any purification and/or other mitigation processes can be used.

Converting calcium sulfide to calcium oxide S200 functions to convert calcium sulfide into calcium oxide. S200 can be performed in an oven (e.g., vacuum oven, furnace, etc.), kiln, fluidized bed reactor (e.g., flowing an oxidizing gas, air, oxygen, steam, etc. at a sufficient pressure to fluidize the reagent(s)), plug flow reactor, continuous stirred-tank reactor, batch reactor, semi-batch reactor, catalytic reactor, and/or in any suitable reaction vessel. The reactor used for S200 can be the same and/or different from S100.

S200 can be performed contemporaneously with (e.g., simultaneously, concurrently, etc.) and/or after (e.g., in separate reaction stages) S100. For instance, when S100 is performed using a carbonaceous reducing agent, S200 is preferably performed after S100 (to minimize contamination of sulfur dioxide formed in S200 with carbon dioxide or other carbon oxides which can be challenging to separate from the sulfur dioxide) such as in a second reaction stage (e.g., performed in a second reactor) after the S100 reaction stage. As another example, when S100 is performed using a hydrogen and/or sulfurous reducing agent (e.g., elemental sulfur, hydrogen sulfide, etc.), S200 can be performed concurrently with S100 (e.g., which can provide a technical advantage of enabling the same heat source to provide heat for both reactions, increasing a sulfur dioxide yield as S100 can also generate sulfur dioxide, facilitate purification of sulfur dioxide as water can be condensed to separate the water from the sulfur dioxide, etc.). However, S200 can be performed with any suitable timing relative to S100.

S200 can include combustion (e.g., oxycombustion, combustion in air, combustion in an oxygen enriched environment, etc.) of the calcium sulfide (e.g., thereby forming CaO and SO₂), electrolysis (e.g., molten salt electrolysis of the CaS to Ca and S where either or both of the Ca and S can thereafter undergo oxidation such as via combustion), comproportionation S250 (e.g., with CaSO₄ or other sulfates as shown for example in FIG. 2A, FIG. 2B, or FIG. 2C), and/or any suitable reactions can be used.

In variants of S200 that include comproportionation of the calcium sulfide, the calcium sulfide is preferably comproportionated with calcium sulfate to form calcium oxide and sulfur dioxide (as well as water). The calcium sulfate can be the same source as the calcium sulfate used in S100 (e.g., unreacted calcium sulfate from S100, calcium sulfate intentionally reserved for S200 rather than processed in S100, etc.) and/or from a different source (e.g., to modify an impurity concentration in the resulting calcium oxide such as in a similar manner as described in S300). As shown for example in FIG. 2A, the ratio of calcium sulfide to calcium sulfate is preferably approximately 1:3 (e.g., 1:2.75, 1:3.1, 1:3.2, etc.). In variations of this example, when the same calcium sulfate source is used in S100 and S200, S100 is preferably performed on approximately ¼ of the calcium sulfate source where the remaining ¾ of the calcium sulfate source is consumed in S200. However, any suitable ratio of calcium sulfide to calcium sulfate can be used. However, other materials (e.g., other metal sulfates) could be used for the comproportionation reaction.

The comproportionation is typically endothermic and therefore performed at an elevated temperature (e.g., a comproportionation temperature). The comproportionation temperature is typically between about 500 and 1500° C. (e.g., 500° C., 600° C., 750° C., 800° C., 900° C., 1000° C., 1100° C., 1200° C., 1300° C., 1400° C., values or ranges therebetween, etc.). However, the comproportionation temperature can be less than 500° C. or greater than 1500° C. The comproportionation temperature can be achieved via combustion (e.g., exothermic combustion of a species within a reaction vessel used in S200, external combustion of a species with heat conducted to the reaction vessel, etc.), using solar heating, using electric heating elements (e.g., inside the reaction vessel, integrated into the walls of the reaction vessel, external to the reaction vessel, etc.), and/or using any suitable heat source. In variants that provide heat using combustion, carbonaceous materials (e.g., carbon-containing materials, majority carbon materials, fossil fuels, hydrocarbons, coke, coal, crude oil, natural gas, plastics, peat, etc.) are preferably not combusted within the reaction vessel as the resulting carbon dioxide can be challenging to separate from the sulfur dioxide. Preferred combusted materials for combustion within the reaction vessel include hydrogen (e.g., as the resulting water can be separated from the sulfur dioxide using condensation), sulfurous materials (e.g., elemental sulfur, hydrogen sulfide, brimstone, sulfur monoxide, disulfur monoxide, disulfur dichloride, thiocyanic acid, etc.), and/or other materials (e.g., that form sulfur dioxide upon combustion, where the combustion products can be efficiently separated from sulfur dioxide, etc.). However, other suitable combustible materials can be used (e.g., carbonaceous materials).

The comproportionation environment is preferably an oxidizing environment (e.g., air, oxygen enriched air, oxygen, etc.). However, the comproportionation environment can be inert (e.g., to hinder, minimize, slow, prevent, etc. side reactions; such as a helium, neon, argon, krypton, xenon, vacuum, etc.) and/or have any suitable environment.

Sulfur dioxide generated in S200 is preferably substantially pure (e.g., >75% SO₂, >80% SO₂, >85% SO₂, >90% SO₂, >95% SO₂, >97% SO₂, >99% SO₂, >99.5% SO₂, >99.9% SO₂, 99.95% SO₂, >99.99% SO₂, values or ranges therebetween, etc. where the percentages can refer to mass percent, volume percent, stoichiometric percent, compositional percent, etc. on a dry basis, i.e., relative to other components except for water, or on a wet basis, i.e. relative to other components inclusive of water). However, the sulfur dioxide can have a lower purity (particularly when S200 includes purifying the SO₂ such as via condensation, selective material capture, etc.). In some variants, the sulfur dioxide can be hydrated (e.g., have a relative humidity greater than about 40%), which can be beneficial for some embodiments of sulfur dioxide electrolysis (e.g., in S300). However, the sulfur dioxide can have any suitable purity.

In variants that leverage the calcium oxide to form a product S300, S300 functions to generate one or more commodity and/or otherwise valuable product from the calcium oxide. Examples of products from the calcium oxide include: clinker, concrete, calcium silicates, cement, calcium carbonate, calcium hydroxide, products that use or include calcium oxide (e.g., as a food additive, insecticide, medicinal use, desiccant, etc.), caustic soda, and/or other products can be formed.

In variants, S300 can include making a formulation using calcium oxide S320 (e.g., co-dissolving, suspending, mixing, etc. calcium oxide with one or more species), reacting calcium oxide to form a product S340, and/or any suitable steps.

As a first illustrative example of S340, calcium oxide can react with water (e.g., be hydrated) to form calcium hydroxide (which can have an additional benefit of generating heat that can be used, for instance, in S100, S200, S500, and/or for other purposes). As a second illustrative example of S340, calcium oxide can react with carbon dioxide (e.g., capture CO₂ from the air, be used to sequester CO₂, etc.) to form calcium carbonate (e.g., which can be further used as aglime). As a third illustrative example of S340, the calcium oxide can be used to neutralize acidic oxides and/or amphoteric oxides (e.g., silica, alumina, iron oxides, phosphorous oxide, sulfur oxides, chlorine oxides, chromium oxides, vanadium oxides, boron oxides, nitrogen oxides, iodine oxides, bromine oxides, manganese oxides, lead oxides, selenium oxides, rhenium oxides, beryllium oxides, gallium oxides, indium oxides, germanium oxides, tin oxides, arsenic oxides, antimony oxides, bismuth oxides, etc.) such as during in the basic steelmaking process and/or other suitable processes. As a fourth illustrative example, the calcium oxide can be reacted with (e.g., in a kiln at a temperature between about silica (and/or silicates), alumina (and/or aluminates), iron oxides (and/or ferrates), carbon dioxide (e.g., after slaking to enable the resulting calcium hydroxide to undergo carbonation), and/or other suitable oxides to form a binder (e.g., cement, aerated concrete, etc.). The fourth illustrative can be particularly beneficial as the binder formed from the calcium oxide produces significantly less carbon dioxide than traditional routes to binder (which often start with calcination of calcium carbonate thereby releasing carbon dioxide). The examples can be combined (e.g., depending on local needs for different species, depending on the amount of available calcium oxide to be consumed, depending on the amount of sulfuric acid and/or other species generated in S400, etc.) and/or performed in isolation. However, other suitable reactions and/or uses of calcium oxide can be realized.

In some embodiments, the calcium oxide can include significant impurity (e.g., gangue material) levels (particularly those performed on samples of calcium oxide derived from phosphogypsum, titanium gypsum, gypsum produced in flue-gas desulfurization, or other refinery waste gypsum). For instance, calcium oxide derived from refinery waste gypsum can have significant levels of radioactive elements (such as uranium, radium, radon, thorium, protactinium, polonium, astatine, lead, bismuth, mercury, etc.), heavy metals (e.g., cadmium, lead, mercury, bismuth, thallium, tin, rhodium, indium, osmium, etc.), fluorides, silica, organic matters, and/or alkalis. As examples of a significant impurity level, the calcium oxide may have a radioactivity exceeding a safe and/or permissible radioactivity (e.g., as measured on an absolute basis such as 0.1 pCi/g, 1 pCi/g, 10 pCi/g, or 100 pCi/g), the calcium oxide may have or release a greater than threshold (e.g., according to a health authority standard) amount of organic material, the calcium oxide may undergo additional (often undesirable) side reactions, and/or the calcium oxide can otherwise have a significant impurity level (e.g., as measured on an absolute basis such as 1 ppb, 10 ppb, 100 ppb, 1000 ppb, 10 ppm, 100 ppm, etc.). When significant impurity levels are present, S300 can include mitigation steps to reduce the impurity(s) and/or reduce an impact of the impurity(s). For instance, S300 can include purifying the calcium oxide (e.g., separating or removing the impurity(s) such as using an ultracentrifuge, hydrocyclone, solvents, reactants, etc.), mixing the calcium oxide with a second calcium oxide source (e.g., calcium oxide derived from mined gypsum, calcium oxide derived from decomposition of limestone, mineral lime, portlandite, dehydrogenated portlandite, etc.), and/or other suitable steps. When the calcium oxide is mixed with a second source of calcium oxide, the relative amounts of each are preferably chosen such that the resulting calcium oxide has less than the threshold amount of impurities (e.g., an insignificant amount of impurities rather than a significant amount of impurities). After purification, the calcium oxide can be >80% pure, >85% pure, >90% pure, >95% pure, >97% pure, >99% pure, >99.5% pure, >99.9% pure, >99.95% pure, >99.99% pure, >99.995% pure, >99.999% pure, have a purity with a range therebetween, have a purity less than 80% pure (e.g., where the calcium oxide is mixed with an impurity that provides technical advantages for a downstream process such as a mixture of calcium oxide and silica advantageous for cement formation), and/or can have any suitable purity.

Purifying the calcium oxide can result in recovery of both the calcium oxide (e.g., with a greater purity) and the impurity(s). The impurity(s) can be accumulated over many iterations of the method and result in accumulation of valuable products to be separated. For instance, actinides, lanthanides, heavy transition metals (e.g., metals in rows 5 or 6 of the periodic table), and/or other impurity(s) can be accumulated until a threshold quantity accumulates (e.g., after which the material(s) can be separated from the other materials). In related embodiments, the purification of the calcium oxide from the impurities can be delayed to enable carbon dioxide capture (e.g., conversion of calcium oxide to calcium carbonate) before performing the separations.

The calcium oxide can be purified chemically (e.g., acid leaching and neutralization, chelation, comproportionation, etc.), physically (e.g., sieving or other techniques that separate impurity(s) based on particle size, magnetic separation, floatation, etc.), thermally, and/or using any suitable purification methods.

In a specific example, sulfuric acid (e.g., from S400) can be used to remove fluorides and/or residual phosphates from the calcium oxide. In this specific example, the fluorides can be converted into hydrofluoric acid (e.g., which can then be sold, used as a commodity chemical, etc.) and metal sulfates (which may then pass through S100 and/or S200 again to result in higher purity calcium or other oxides). In another example, the calcium oxide can be calcined (e.g., at a temperature between about 100° C. and 250° C.) which can result in removal of water, fluorine (e.g., as hydrogen fluoride), and/or other impurities. In another example, floatation (e.g., reverse floatation, direct floatation, froth floatation, etc.) can be used to remove impurity(s) (e.g., organic materials, silica, etc.) from the calcium oxide. In another example, chelating agents (e.g., citrate, citric acid, EDTA, ascorbic acid, etc.) can be used to transform fluorides, phosphates, silicates, and/or other impurity species into water washable materials. Note that these examples can be used in isolation and/or combination to achieve suitable purification.

In variants that include oxidizing sulfur dioxide to sulfuric acid S400, S400 can function to generate sulfuric acid (and/or other commodity chemicals) from sulfur dioxide (e.g., as produced in S100 and/or S200). The SO₂ processed in S400 is preferably substantially pure (e.g., at least 80%, 85%, 90%, 95%, 97.5%, 99%, 99.9%, 99.95%, 99.99%, 99.995%, 99.999%, etc. SO₂ by mass, by stoichiometry, by volume, etc.), where S400 can include purifying sulfur dioxide stream from S100 and/or S200 (e.g., condensing steam to separate steam from the SO₂). Impurities in the SO₂ are preferably substantially inert to the reactions or processes performed in S400 (e.g., act as carrier or inert gases). For example, impurities in the SO₂ can include air (or constituents thereof such as N₂, O₂, Ar, Ne, H₂O, etc.), noble gases (e.g., He, Ne, Ar, Kr, Xe, etc.), sulfur trioxide, and/or any suitable impurities can be present. Carbon dioxide is preferably less than about 1% (e.g., by stoichiometry, by volume, by mass, etc.) of the sulfur dioxide. However, any suitable impurities can be present in any suitable concentration.

S400 can include oxidizing the sulfur dioxide using the contact process, using the wet sulfuric acid process, using the metabisulfite process, using the lead chamber process, using sulfur dioxide depolarized electrolysis (which can be particularly beneficial for coproducing sulfuric acid and hydrogen), and/or using any suitable process(s).

In a variant of S400 that oxidizes the sulfur dioxide using the contact process, the sulfur dioxide can be oxidized (e.g., in air, in an oxygen enriched environment, with substantially pure oxygen, etc.) at a temperature greater than a threshold temperature (e.g., 4000 C, 450° C., 500° C., 600° C., 750° C., 900° C., 1000° C., 1500° C., etc.) and at a pressure approximately equal to atmospheric pressure (e.g., 0.5 bar, 0.75 bar, 1 bar, 2 bar, 5 bar, etc.) in the presence of a catalyst (e.g., vanadium (V) oxide, platinum, etc.) to form sulfur trioxide, dissolving the sulfur dioxide in concentrated sulfuric acid (e.g., to form oleum), diluting the oleum to sulfuric acid, and/or other suitable steps.

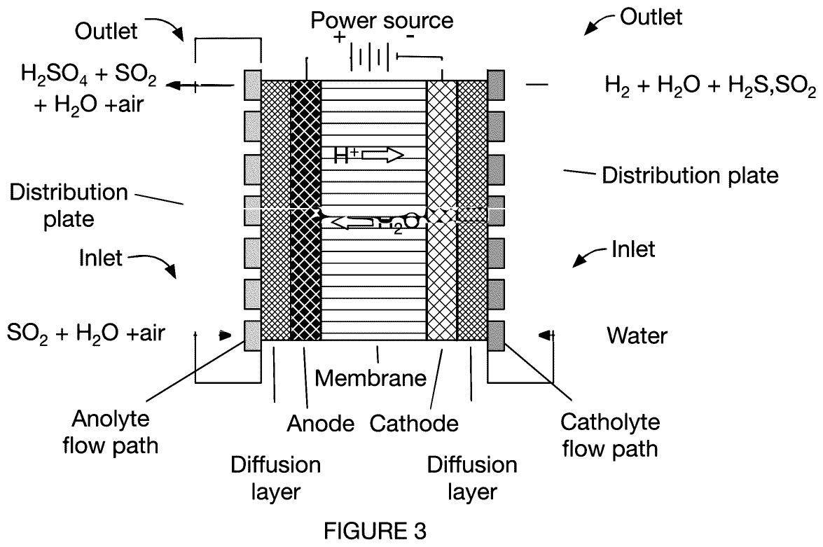

In a variant of S400 the oxidizes the sulfur dioxide using electrolysis, S400 can be performed using a sulfur dioxide depolarized electrolyzer (as shown for example in FIG. 3) as described in U.S. patent application Ser. No. 18/376,316 titled ‘SULFUR DIOXIDE DEPOLARIZED ELECTROLYSIS AND ELECTROLYZER THEREFORE’ filed 3 Oct. 2023 which is incorporated in its entirety by this reference. However, S400 can be performed using any suitable electrolyzer.

Typically, electrolytic variants of S400 require input energy (e.g., electricity, heat, etc.) to operate. As an illustrative example, when sulfur dioxide oxidation to sulfuric acid is coupled with water hydrolysis to hydrogen, an electrical potential of at least 0.17 V can be required (and often an overpotential on the order of hundreds of mV such as 100 mV, 200 mV, 300 mV, 500 mV, 700 mV, etc. is applied).

A current density during an electrolytic variant of S400 is preferably at least about 1 A/cm² (e.g., 0.95 A/cm², 1.1 A/cm², 1.2 A/cm², 1.5 A/cm², 2 A/cm², etc.). However, any suitable current density can be used.

The sulfur dioxide oxidation is preferably performed at elevated temperatures (e.g., temperatures above room temperature such as 50° C., 60° C., 70° C., 80° C., 90° C., 100° C., 120° C., 150° C., 180° C., 200° C., 225° C., 250° C., 300° C., 350° C., 374° C., values or ranges therebetween, etc.). However, the sulfur dioxide oxidation can be performed at any temperature.

A differential pressure (e.g., between inlet anolyte and outlet reduced catholyte, between sulfur dioxide and hydrogen, between inlet anolyte and inlet catholyte, between sulfur dioxide and water, etc.) is preferably greater than about 20 Bar (e.g., 20 Bar, 22 Bar, 25 Bar, 30 Bar, 35 Bar, 40 Bar, 50 Bar, 100 Bar, etc.). However, the differential pressure can have any suitable value. To achieve the differential pressure, the anolyte pressure can be fixed; the catholyte pressure can be fixed; the reduced catholyte pressure can be fixed; the anolyte, catholyte, and/or reduced catholyte pressures can vary (e.g., in a concerted manner to maintain a target differential pressure); the anolyte, catholyte, and/or reduced catholyte can be pressurized; and/or the differential pressure can otherwise be achieved. As a first illustrative example, a sulfur dioxide pressure can be about 1 Bar and a Hydrogen partial pressure can be about 30 Bar (resulting in a differential pressure of about 30 Bar). As a second illustrative example, at 80° C. sulfur dioxide's boiling point is about 19 Bar and a Hydrogen partial pressure can be maintained at about 50 Bar (to result in a differential pressure of about 30 Bar). In a variation of the second illustrative example, the Hydrogen partial pressure can be maintained at about 30 Bar (resulting in a differential pressure of about 10 Bar).

Examples of catalysts for these variants of S400 can include: metal oxides (e.g., ruthenium oxide, palladium oxide, iridium oxide, titanium oxide, nickel oxide, iron oxide, etc.), nanoparticles (e.g., of an electrode material), carbon-based materials (e.g., carbon nanotubes, graphene, graphite, etc.), metal-organic frameworks (e.g., MOFs), polymer(s), alloys (e.g., Pt/C, PtRu/c, PtCo/C, etc.), combinations thereof, and/or any suitable materials.

The operation parameters (e.g., current density, electrical potential, amount of overpotential, temperature, pressure, differential pressure between inlet anolyte and outlet catholyte, differential pressure between inlet anolyte and inlet catholyte, etc.) can be limited by material compatibility (e.g., separator compatibility, separator conductivity, etc.), electrolyzer wall compatibility (e.g., resistance of, rate of reaction of, etc. an electrolyzer material to reaction with sulfuric acid at the electrolysis temperature), and/or by any suitable temperature limiting component. For instance, when a nafion separator is used, the electrolysis temperature may be limited to at most about 80° C. as the separator becomes desiccated resulting in insufficient electrical and/or ionic conductivity. However, the sulfur dioxide electrolysis can be performed in any suitable conditions.

S400 is preferably performed without recycling sulfuric acid into sulfur dioxide (i.e., sulfuric acid is not used catalytically, S400 is performed as a feedthrough process, etc.). However, sulfuric acid can be reduced to sulfur dioxide (e.g., for catalytic or cyclic performance of S400; for instance when excess sulfuric acid is generated relative to hydrogen, to maintain a target sulfur dioxide concentration or pressure, when insufficient sulfur dioxide is generated in S100 and/or S200, etc.). In an illustrative example, less than about 5% of sulfuric acid generated in S400 can be reduced to sulfur dioxide and reintroduced into the electrolyzer (via the anolyte inlet).

As an illustrative example of electrolytic oxidation of SO₂, SO₂ can be oxidized concurrently with reduction of H₂O (e.g., to produce sulfuric acid and hydrogen) as described in U.S. patent application Ser. No. 18/376,312 titled ‘SULFUR DIOXIDE DEPOLARIZED ELECTROLYSIS AND ELECTROLYZER THEREFORE’ filed 3 Oct. 2023 which is incorporated in its entirety by this reference. However, electrolytic oxidation of SO₂ can be performed in any manner.

Additionally and/or alternatively, the sulfur dioxide can be reduced (e.g., used as an oxidizing agent). For example, the sulfur dioxide can be used to oxidize hydrogen disulfide into sulfur (such as according to the Claus process where the resulting sulfur could be used as a reducing agent in S100).

Processing products from sulfur dioxide oxidation S500 functions to utilize the products (e.g., sulfuric acid, hydrogen, etc.) generated in S400. S500 can result in production of calcium sulfate (or materials that can be used to generate calcium sulfate) to form a closed loop process for the method. However, S500 does not have to result in the production of calcium sulfate or precursors thereto (e.g., because excess calcium sulfate is available, because other uses need to be prioritized, etc.). The products produced in S400 are preferably used synergistically (e.g., cooperatively, to achieve the same end goal, in parallel processes that cross streams, etc.). However, the products do not have to be used synergistically.

Examples of processes and/or applications for use of sulfuric acid include: fertilizer production (e.g., superphosphate production such as ammonium phosphate, ammonium sulfate, etc.), chemical industry (e.g., production of detergents, synthetic resin, dyestuffs, pharmaceuticals, petroleum catalysts, petroleum purification, insecticides, antifreeze, acid production, etc.), oil well acidizing, aluminium reduction, paper sizing, water treatment, pigments (e.g., paints, enamels, printing inks, coated fabrics and paper, etc.), production of explosives, production of cellophane, production of acetate and/or viscose textiles, production of lubricants, production of non-ferrous metals, production of batteries (e.g., lead-acid batteries, etc.), ore extraction (e.g., nickel laterite ore mining; copper smelting; titanium mining such as extraction of titanium from ilmenite, anatase, brookite, perovskite, rutile, titanite, akaogite, etc. where calcium sulfate formed in these processes can be used as a feedstock in S100 and/or S200; etc.), pickling of metal, and/or other suitable applications.

For example, S500 can include using the sulfuric acid and/or hydrogen (e.g., from S400, from other sources) for fertilizer production. In this variant, the hydrogen can be used (e.g., in combination with nitrogen) to produce ammonia (e.g., via the Haber Bosch process) and the sulfuric acid can be used to produce phosphoric acid (e.g., via reaction of phosphate ore such as calcium phosphate resulting in the production of phosphogypsum which can then be used in S100 and/or S200). The ammonia and phosphoric acid can then be reacted to form ammonium phosphate (e.g., monoammonium phosphate, diammonium phosphate, etc.) fertilizer. In a variation of this variant, sulfuric acid can be reacted with ammonia to form ammonium sulfate (e.g., monoammonium sulfate, diammonium sulfate, etc.) fertilizer. In this example, the hydrogen and/or sulfuric acid may need to be purified (e.g., to remove residual SO₂, remove H₂S, etc.), concentrated (e.g., to a threshold concentration such as via evaporation), and/or otherwise processed prior to use.

In some embodiments, one or more of the products produced in S400 (particularly H₂SO₄ and/or H₂, but also heat, pressure, other chemicals, etc.) can be used synergistically with calcium oxide (or other products derived from calcium oxide such as calcium carbonate, calcium hydroxide, etc.). For example, nickel laterite mining can use sulfuric acid to separate nickel from the rest of the ore, hydrogen can be used to reduce nickel oxide (and/or other oxides). In variations of this example, calcium oxide can be leveraged for growth and/or aggregation of ferronickel particles (e.g., from saprolitic laterite ore—where the sulfuric acid can be used to extract the nickel therefrom, where the ferronickel particles can be used directly, etc.). However, the products of S400 can otherwise be used synergistically with and/or cooperatively with calcium oxide and/or can be used in isolation from the calcium oxide.

However, other applications of sulfuric acid can be performed (particularly, but not exclusively, in variants of S100 that use hydrogen generated in S400).

In an illustrative example, S500 can be performed in a manner as described for processing products as described in U.S. patent application Ser. No. 18/376,312 titled ‘SULFUR DIOXIDE DEPOLARIZED ELECTROLYSIS AND ELECTROLYZER THEREFORE’ filed 3 Oct. 2023 which is incorporated in its entirety by this reference. However, S500 can include any suitable steps and/or processes.

In a first illustrative example, a method can include: at a reduction temperature between 500° C. and 1500° C., reducing phosphogypsum to calcium sulfide and sulfur dioxide using elemental sulfur as a reducing agent, wherein oxidation of the elemental sulfur produces heat which enables the reaction to proceed at elevated temperature (e.g., the reduction temperature); at a reaction temperature, reacting phosphogypsum remaining after step with the calcium sulfide to form calcium oxide and sulfur dioxide; and electrochemically oxidizing the sulfur dioxide to sulfuric acid and hydrogen, wherein the hydrogen is used to reduce nitrogen to ammonia according to the Haber-Bosch process, wherein the sulfuric acid is used to produce the phosphogypsum and phosphoric acid from calcium phosphate, and wherein the phosphoric acid and ammonia react to form an ammonium phosphate fertilizer. In variations of the first illustrative example, a purity of the sulfur dioxide is at least 90% (e.g., on a dry basis). In variations, the method of the first illustrative example can include removing radioactive material from the phosphogypsum using a hydrocyclone. In variations, the method of the first illustrative example can be performed in a fluidized bed reactor, wherein a gas feed for the fluidized bed reactor can include air, oxygen, and/or steam. In variations, the method of the first illustrative example can include separating the steam from the sulfur dioxide by condensation. In variations, the method of the first illustrative example can include reacting the calcium oxide with silica to form a calcium silicate cement.

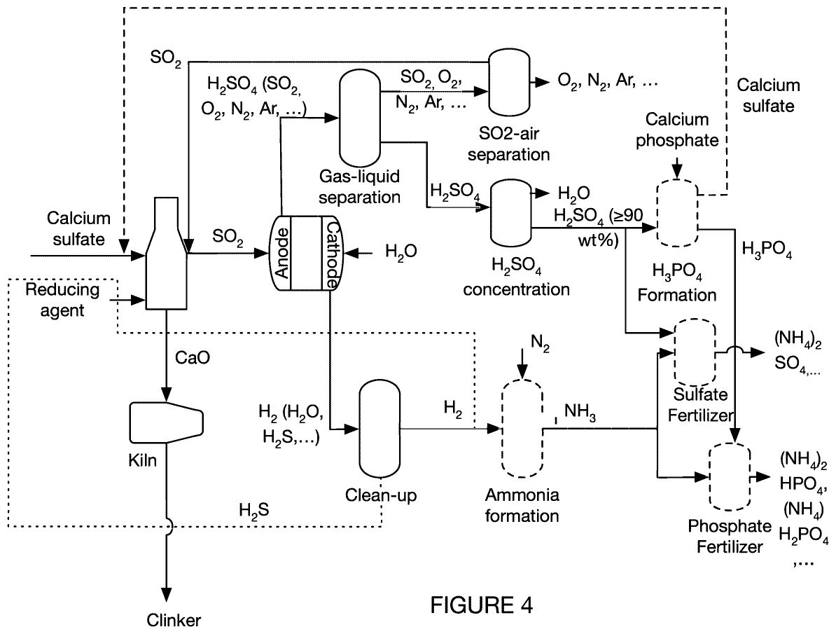

A second illustrative example (as shown for instance in FIG. 4) of a method can include: reducing calcium sulfate to calcium sulfide using a reducing agent at an elevated temperature (e.g., the reduction reaction temperature); reacting remaining calcium sulfate and/or a second source of calcium sulfate with the calcium sulfide to form calcium oxide and sulfur dioxide at a reaction temperature; and oxidizing the sulfur dioxide to sulfuric acid. In variations of the method of the second illustrative example, the reducing agent can include less than about 10% carbonaceous material. In variations of the method of the second illustrative example, the reducing agent can include at least one of elemental sulfur, hydrogen sulfide, or hydrogen. In variations of the method of the second illustrative example, the reducing agent can include the elemental sulfur, wherein combustion of the elemental sulfur heats the calcium sulfate to the reducing temperature. In variations of the method of the second illustrative example, combustion of the elemental sulfur and reduction of the calcium sulfate using the elemental sulfur can result in formation of the sulfur dioxide. In variations of the method of the second illustrative example, the reducing temperature can be approximately 1000° C. In variations of the method of the second illustrative example, between 0.5 and 5 moles of sulfur atoms from the elemental sulfur are used per mole of calcium sulfate. In variations of the method of the second illustrative example, oxidizing the sulfur dioxide to sulfuric acid can include electrochemically oxidizing the sulfur dioxide to the sulfuric acid and hydrogen using a sulfur dioxide depolarized electrolyzer and/or oxidizing the sulfur dioxide using the contact process. In variations of the method of the second illustrative example, the hydrogen can be used to reduce nitrogen to ammonia according to the Haber-Bosch process, the sulfuric acid can be used to produce the calcium sulfate and phosphoric acid from calcium phosphate, and the phosphoric acid and ammonia can react to form an ammonium phosphate fertilizer. In variations of the method of the second illustrative example, radium sulfate (or other impurities) can be separated from the calcium sulfate using a hydrocyclone. In variations of the method of the second illustrative example, gypsum can be mixed with the byproduct calcium sulfate. In variations of the method of the second illustrative example, the reducing agent can include hydrogen. In variations of the method of the second illustrative example, calcium sulfate reduction and calcium sulfide comproportionation can be performed in multiple stages, wherein the reducing agent and/or a combustible material used to heat the calcium sulfate reduction can include (e.g., only include, include a majority of, etc.) a carbon-containing material. In variations of the method of the second illustrative example, the calcium oxide can be used to form a cement. In variations of the method of the second illustrative example, the calcium oxide can be mixed with quicklime to reduce a radioactivity of the calcium oxide to less than a threshold radioactivity. In variations of the third illustrative example, a purity of the sulfur dioxide can be at least 75% (e.g., on a dry basis).

Alternative embodiments implement the above methods and/or processing modules in non-transitory computer-readable media, storing computer-readable instructions that, when executed by a processing system, cause the processing system to perform the method(s) discussed herein (e.g., by operating a chemical plant to perform the requisite operations). The instructions can be executed by computer-executable components integrated with the computer-readable medium and/or processing system. The computer-readable medium may include any suitable computer readable media such as RAMs, ROMs, flash memory, EEPROMs, optical devices (CD or DVD), hard drives, floppy drives, non-transitory computer readable media, or any suitable device. The computer-executable component can include a computing system and/or processing system (e.g., including one or more collocated or distributed, remote or local processors) connected to the non-transitory computer-readable medium, such as CPUs, GPUs, TPUS, microprocessors, and/or FPGA/ASIC. However, the instructions can alternatively or additionally be executed by any suitable dedicated hardware device.

Embodiments of the system and/or method can include every combination and permutation of the various system components and the various method processes, wherein one or more instances of the method and/or processes described herein can be performed asynchronously (e.g., sequentially), contemporaneously (e.g., concurrently, in parallel, etc.), or in any other suitable order by and/or using one or more instances of the systems, elements, and/or entities described herein. Components and/or processes of the preceding system and/or method can be used with, in addition to, in lieu of, or otherwise integrated with all or a portion of the systems and/or methods disclosed in the applications mentioned above, each of which are incorporated in their entirety by this reference.

As used herein, “substantially” or other words of approximation (e.g., “about,” “approximately,” etc.) can be within a predetermined error threshold or tolerance of a metric, component, or other reference (e.g., within 0.001%, 0.01%, 0.1%, 1%, 5%, 10%, 20%, 30% of a reference), or be otherwise interpreted.

As a person skilled in the art will recognize from the previous detailed description and from the figures and claims, modifications and changes can be made to the preferred embodiments of the invention without departing from the scope of this invention defined in the following claims.

We claim:

1. A method comprising:
a) at a reduction temperature between 500° C. and 1500° C., reducing phosphogypsum to calcium sulfide and sulfur dioxide using elemental sulfur as a reducing agent, wherein oxidation of the elemental sulfur produces heat to achieve the reduction temperature;
b) at a reaction temperature, reacting phosphogypsum remaining after step a) with the calcium sulfide to form calcium oxide and sulfur dioxide; and
c) electrochemically oxidizing the sulfur dioxide to sulfuric acid and hydrogen, wherein the hydrogen is used to reduce nitrogen to ammonia according to the Haber-Bosch process, wherein the sulfuric acid is used to produce the phosphogypsum and phosphoric acid from calcium phosphate, and wherein the phosphoric acid and ammonia react to form an ammonium phosphate fertilizer.

2. The method of claim 1, further comprising, before step a) removing radioactive material from the phosphogypsum using a hydrocyclone.

3. The method of claim 1, wherein steps a) and b) are performed in a fluidized bed reactor, wherein a gas feed for the fluidized bed reactor comprises steam.

4. The method of claim 3, wherein the steam is separated from the sulfur dioxide by condensation, wherein a purity of the sulfur dioxide from steps a) and b) is at least 90% on a dry basis.

5. The method of claim 1, wherein the calcium oxide is reacted with silica to form a calcium silicate cement.

6. A method comprising:
a) reducing calcium sulfate to calcium sulfide using a reducing agent at a reducing temperature;
b) reacting calcium sulfate remaining after step a) with the calcium sulfide to form calcium oxide and sulfur dioxide at a reaction temperature; and
c) oxidizing the sulfur dioxide to sulfuric acid.

7. The method of claim 6, wherein the reducing agent comprises less than 10% carbonaceous material.

8. The method of claim 7, wherein the reducing agent comprises at least one of elemental sulfur, hydrogen sulfide, or hydrogen.

9. The method of claim 8, wherein the reducing agent comprises the elemental sulfur, wherein combustion of the elemental sulfur heats the calcium sulfate to the reducing temperature.

10. The method of claim 9, wherein combustion of the elemental sulfur and reduction of the calcium sulfate using the elemental sulfur further result in formation of the sulfur dioxide.

11. The method of claim 9, wherein the reducing temperature is approximately 1000° C.

12. The method of claim 9, wherein between 0.5 and 5 moles of sulfur atoms from the elemental sulfur are used per mole of calcium sulfate.

13. The method of claim 6, wherein oxidizing the sulfur dioxide to sulfuric acid comprises electrochemically oxidizing the sulfur dioxide to the sulfuric acid and hydrogen using a sulfur dioxide depolarized electrolyzer.

14. The method of claim 13, wherein the hydrogen is used to reduce nitrogen to ammonia according to the Haber-Bosch process, wherein the sulfuric acid is used to produce the calcium sulfate and phosphoric acid from calcium phosphate, and wherein the phosphoric acid and ammonia react to form an ammonium phosphate fertilizer.

15. The method of claim 6, wherein before step a) radium sulfate is separated from the calcium sulfate using a hydrocyclone.

16. The method of claim 6, wherein before step a) gypsum is mixed with the calcium sulfate.

17. The method of claim 6, wherein the reducing agent comprises hydrogen.

18. The method of claim 6, wherein step a) and step b) are performed in multiple stages, wherein the reducing agent comprises a carbon-containing material.

19. The method of claim 6, wherein the calcium oxide is used to form a cement.

20. The method of claim 19, wherein the calcium oxide is mixed with quicklime to reduce a radioactivity of the calcium oxide to less than a threshold radioactivity.

21. The method of claim 6, wherein a purity of the sulfur dioxide is at least 90% on a dry basis.
